(19) United States
(12) Patent Application Publication
(10) Pub. No.: US 2015/0323929 A1
(43) Pub. Date: Nov. 12, 2015

(54) EQUIPMENT PREVENTIVE MAINTENANCE SCHEDULING

(71) Applicant: INTERNATIONAL BUSINESS MACHINES CORPORATION, ARMONK, NY (US)

(72) Inventors: SHEFALI BANSAL, BANGALORE (IN); TAPAN DEY, BANGALORE (IN)

(21) Appl. No.: 14/634,952

(22) Filed: Mar. 2, 2015

Related U.S. Application Data
(63) Continuation of application No. 14/274,343, filed on May 9, 2014.

(51) Int. Cl. G05B 23/02

(52) U.S. Cl. CPC G05B 23/0283

(57) ABSTRACT

A method, system, and/or computer program product schedules preventive maintenance on a unit of equipment. An outage on a unit of equipment, which is the result of a maintenance operation being performed on a subcomponent of the unit of equipment, is detected. A determination is made that the maintenance operation is a superseding maintenance operation, which renders a subsequently scheduled minor maintenance operation on the subcomponent of the unit of equipment unnecessary. A critical maintenance operation on the subcomponent of the unit of equipment is also identified. Thus, the critical maintenance operation, but not the minor maintenance operation, is performed while executing the superseding maintenance operation on the subcomponent of the unit of equipment during the outage.

### BACKGROUND

The present disclosure relates to the field of computers, and specifically to the use of computers in managing equipment. Still more particularly, the present disclosure relates to managing preventive maintenance schedules for equipment.

In order to operate efficiently and without breaking down, most mechanical equipment requires periodic preventive maintenance. Various components and/or subcomponents of equipment each have their own preventive maintenance schedules, thus posing a challenge when attempting to schedule and/or consolidate these different preventive maintenance schedules.

### SUMMARY

A method, system, and/or computer program product schedules preventive maintenance on a unit of equipment. An outage on a unit of equipment, which is the result of a maintenance operation being performed on a subcomponent of the unit of equipment, is detected. A determination is made that the maintenance operation is a superseding maintenance operation, which renders a subsequently scheduled minor maintenance operation on the subcomponent of the unit of equipment unnecessary. A critical maintenance operation on the subcomponent of the unit of equipment is also identified. Thus, the critical maintenance operation, but not the minor maintenance operation, is performed while executing the superseding maintenance operation on the subcomponent of the unit of equipment during the outage.

### BRIEF DESCRIPTION OF THE DRAWINGS

FIG. 1 depicts an exemplary system and network in which the present disclosure may be implemented;

FIG. 2 illustrates exemplary timelines for consolidating preventive maintenance events according to one embodiment of the present invention;

FIG. 3 depicts exemplary timelines for consolidating preventive maintenance events according to one embodiment of the present invention in which superseding maintenance events are incorporated;

FIG. 4 illustrates an exemplary unit of equipment that is monitored by sensors and managed by a preventive maintenance scheduling server; and

FIG. 5 is a high level flow-chart of one or more operations performed by one or more processors to schedule and/or manage preventive maintenance on equipment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

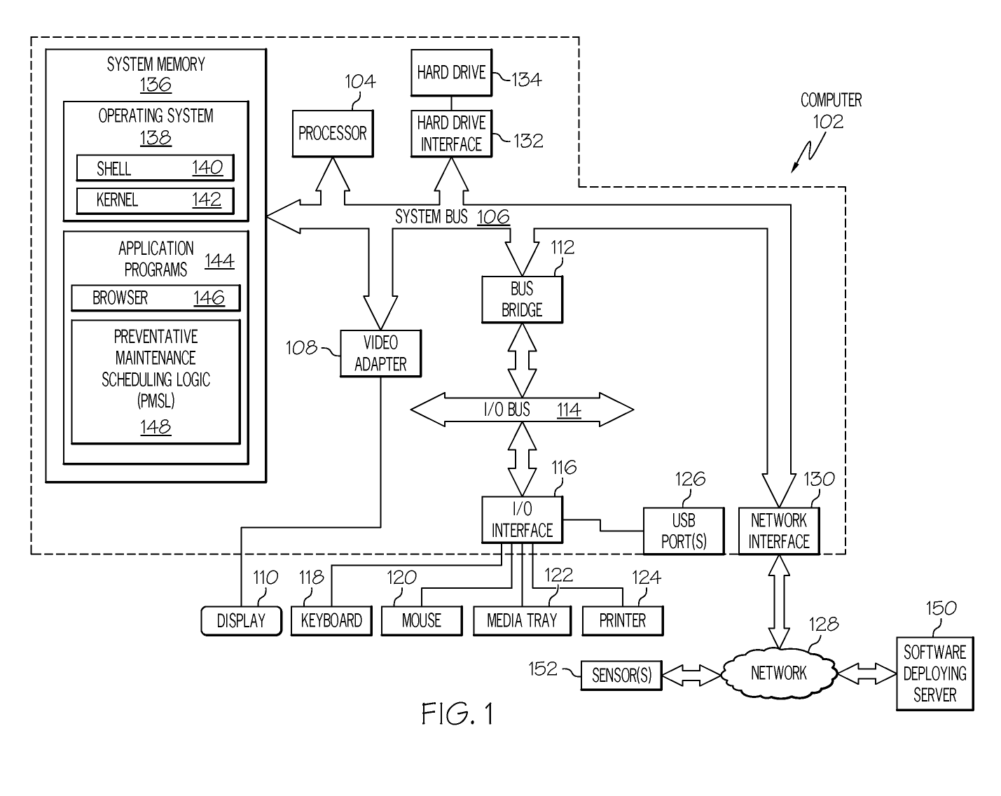

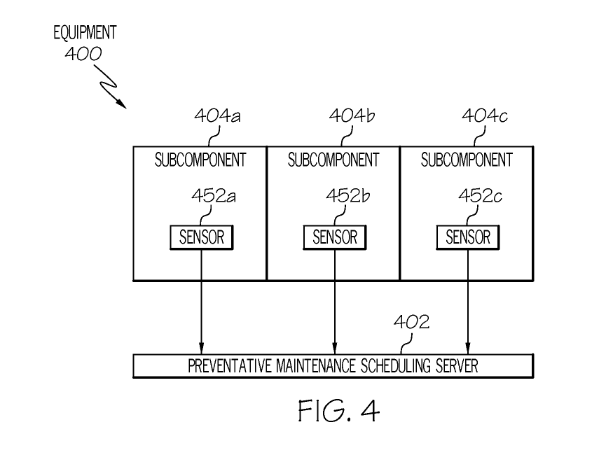

With reference now to the figures, and in particular to FIG. 1, there is depicted a block diagram of an exemplary system and network that may be utilized by and/or in the implementation of the present invention. Note that some or all of the exemplary architecture, including both depicted hardware and software, shown for and within computer 102 may be utilized by software deploying server 150, as well as the Preventive Maintenance Scheduling (PMS) server 402 shown in FIG. 4.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, as well as sensor(s) 152 (which monitor one or more components on a unit of equipment) using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

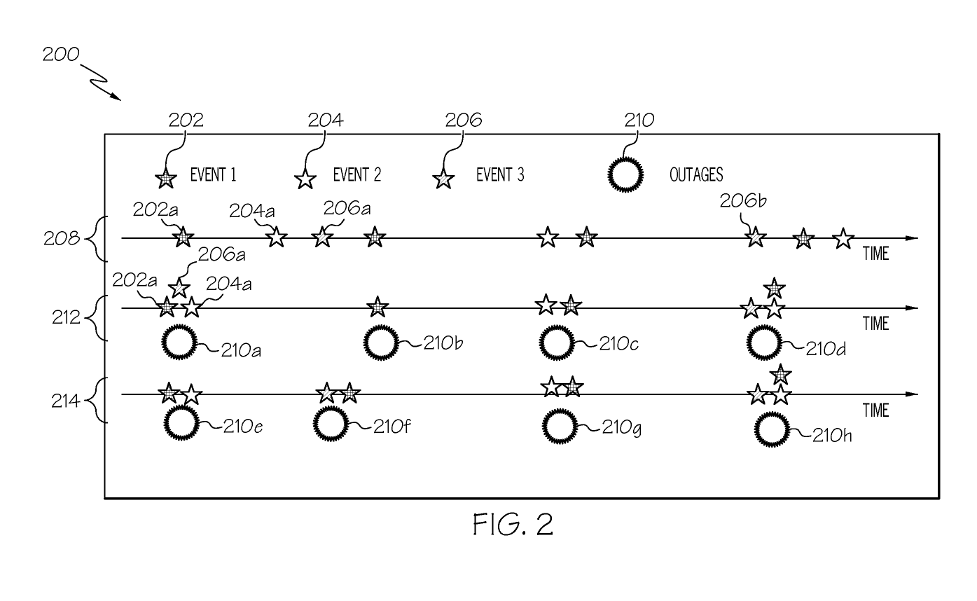

Application programs 144 in computer 102's system memory (as well as software deploying server 150's system memory) also include a Preventive Maintenance Scheduling Logic (PMSL) 148. PMSL 148 includes code for implementing the processes described below, including those described in FIGS. 2-5. In one embodiment, computer 102 is able to download PMSL 148 from software deploying server 150, including in an on-demand basis, wherein the code in PMSL 148 is not downloaded until needed for execution. Note further that, in one embodiment of the present invention, software deploying server 150 performs all of the functions associated with the present invention (including execution of PMSL 148), thus freeing computer 102 from having to use its own internal computing resources to execute PMSL 148.

Note that the hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, exemplary timelines for consolidating preventive maintenance events according to one embodiment of the present invention are presented in a graph 200. As depicted, the timelines in graph 200 depict times at which preventive maintenance is scheduled for a unit of equipment and/or components of the unit of equipment. These scheduled preventive maintenance operations are depicted as “Event 1”, represented by symbol 202; “Event 2”, represented by symbol 204; and “Event 3”, represented by symbol 206. Exemplary timeline 208 thus shows when these events are initially scheduled to occur. However, in order to perform any of the preventive maintenance operations (events) represented by symbols 202, 204, 206, the equipment being worked on must be shut down. These shutdowns are known as “outages”, as depicted by symbol 210.

For example, consider timeline 212. In order to perform scheduled “Event 1” (represented by symbol 202a) on a particular unit of equipment and/or component thereof, there is a shutdown/outage to the equipment/component, as represented by symbol 210a. As also depicted in timeline 212, Event 2 and Event 3 (also shown on timeline 212 by symbols 204a and 206a above symbol 210a) are also performed during the shutdown/outage represented by symbol 210a. As shown in timeline 208, the next Event 2 and Event 3 (i.e., maintenance operations) were initially scheduled to occur after Event 1. However, a decision has been made to accelerate, while the equipment is shutdown (see symbol 210a), the timetable for performing the maintenance items (“pull back the event”) represented by symbols 204a and 206a. This decision has been made based on several factors.

First, in one embodiment Event 2 (symbol 204a) and Event 3 (symbol 206a) must be technically feasible to occur during the outage represented by symbol 210a. That is, the outage may involve shutting down certain components that must be operational in order to perform Event 2 and/or Event 3. For example, Event 1 may be to replace a power supply to a control system for the equipment being maintained during the outage, thus requiring the control system to be powered off. However, Event 2 may be a system test of that control system, which cannot occur while the control system is powered off (i.e., there is an “outage” to the control system and thus the equipment being maintained). If so, then Event 2 will occur at its initially scheduled time shown in timeline 208, rather than during the outage (symbol 210a) that resulted from the performance of Event 1 (symbol 202a).

Second, in one embodiment there must be an overall reduction in the length of time that the equipment is shutdown (in an “outage”) to accelerate when an event occurs. For example, assume that Event 2 is merely updating software to a control panel that manages the equipment, and that such updating can be performed “hot” (i.e., while the equipment is running without stopping or even degrading the performance of the equipment). Assuming that making this update during the outage represented by symbol 210a will extend the length of that outage, then there is no justification for performing Event 2 during that outage. Thus, Event 2 will be performed at its original timeslot shown in timeline 208.

Third, in one embodiment there must be an economic incentive to perform Event 2 and/or Event 3 during the outage represented by symbol 210a. For example, assume that Event 2 is to replace a motor in the equipment being maintained. A cost/benefit analysis is performed to determine if it is financially worthwhile to do so during the outage represented by symbol 210a. That is, by replacing the motor before the end of its useful life (i.e., at the time shown for Event 2 on timeline 208), then some of the life of the motor is wasted. However, if it would cost more to replace the motor at its initially scheduled time (shown on timeline 208) than during the outage represented by symbol 210a, then Event 2 will occur during that outage. For example, replacing the motor may require the equipment to be shut down and partially disassembled in order to replace the motor. This results in 1) loss of revenue due to the equipment being shut down, and 2) labor costs to disassemble the equipment in order to access the motor. Both of these costs would be avoided if the motor was replaced while the equipment was already disassembled during the outage represented by symbol 210a. A comparison of the cost/benefit associated with performing Event 2 at its regularly scheduled time (see timeline 208) or during the outage (see symbol 210a) will determine when Event 2 occurs.

Fourth, in one embodiment, only critical events are pulled back (i.e., occur earlier than originally scheduled) to occur during an outage. A critical event is defined as maintenance to equipment, or a component thereof, that if not performed within a certain timeframe, is predetermined to result in a failure (according to predefined parameters) to the equipment. For example, if a critical rotor bearing is not replaced every six months, then the rotor bearing will have a catastrophic (i.e., total) failure within the seventh month, causing the rotor to seize and destroy/disable the equipment. If such a critical event (e.g., Event 3 represented by symbol 206a) is pulled back to occur during the outage represented by symbol 210a, then the next required occurrence of Event 3 (represented by symbol 206b in timeline 208) must be shifted to the left (i.e., “pulled back”), in order to occur within the requisite 6-month window. The decision to do so will be based on a cost/benefit analysis as described above, and/or by determining whether there will be another scheduled outage (e.g., an outage such as that depicted by symbols, 210b, 210c, 210d in timeline 212) during which the next Event 3 (symbol 206b) can take place. Note that in one embodiment, critical events are defined and scheduled statically (i.e., by a manufacturer's recommendations). In another embodiment, critical events are dynamically defined and scheduled according to real-time conditions, as described below with reference to FIG. 4.

Timeline 214 shows other outages (symbols 210e, 210f, 210g, 210h) during which various events may be consolidated/accelerated, in a manner similar to that described for timeline 212.

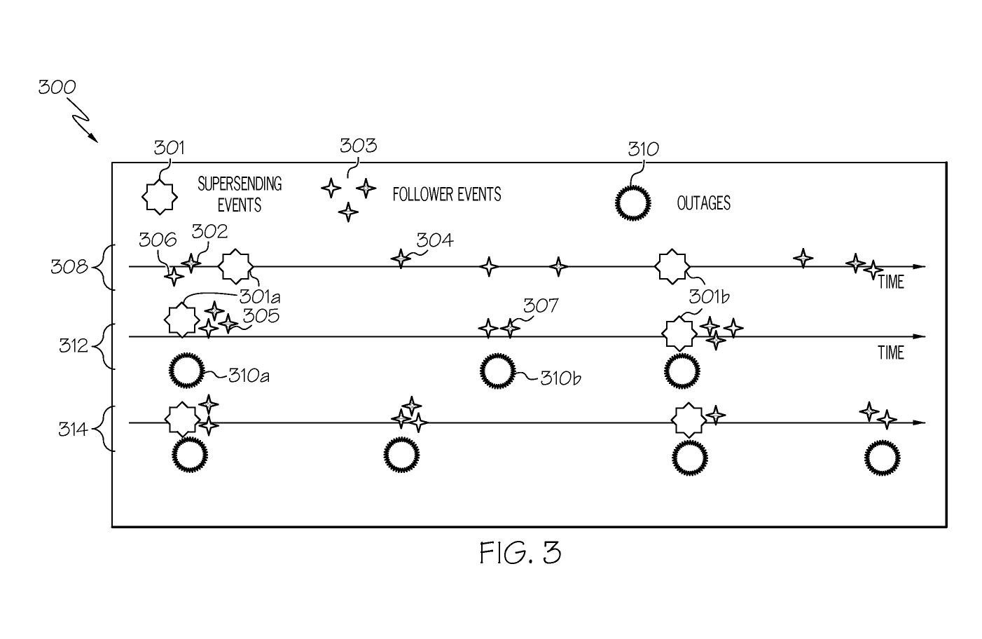

With reference now to FIG. 3, a graph 300 depicts exemplary timelines for consolidating preventive maintenance events according to one embodiment of the present invention in which superseding maintenance events are incorporated. A superseding event is defined as a major maintenance event to equipment that causes one or more follower events to be unnecessary to maintaining the equipment. For example, follower events (i.e., maintenance events that were initially scheduled to occur after the superseding event) may include replacing individual roller bearings in a roller bearing, lubricating the roller bearing, inspecting the roller bearing, etc. The superseding event may be replacing the entire roller bearing with a new pre-lubricated roller bearing, which would make all of the follower events unnecessary to protect the equipment being maintained. Thus, in one embodiment of the present invention, when any superseding event(s) occurs, then with respect to that superseding event(s) all the follower events will be inherently performed by the superseding event(s). By mapping the superseding event to the follower events that are superseded by the superseding event, the total number of outages is reduced.

In one embodiment, when any superseding event occurs and there are follower events with respect to the superseding event, then only the critical parts will be subject to the follower events (maintenance), in order to further reduce the outage time, event cost and finally the total maintenance cost. For example, in the roller bearing example presented above, assume that even though the replacement roller bearing is supposed to be pre-lubricated, if it was not pre-lubricated, then there will quickly be a catastrophic failure to the equipment. Thus, “lubrication” is deemed to be a critical event, and will be performed by pumping grease into the roller bearing, just to be certain that the roller bearing is properly lubricated. However, in this embodiment, non-critical events are not performed, since doing so would unnecessarily extend the length of time that the equipment is off line. An exemplary non-critical event may be to check the viscosity of the grease in the roller bearing. While use of an optimal weight/viscosity of grease will cause the roller bearing to give the least amount of resistance when turning, using another weight/viscosity of grease will allow the equipment to still turn within nominal ranges, even if such performance is not optimal.

Thus, as depicted in graph 300 in FIG. 3, assume that timeline 308 depicts initially scheduled superseding events (represented by symbols 301) and follower events (represented by symbols 303 (more specifically symbols 302, 304, 306) and analogous to the follower events represented by symbols 202, 204, and 206 in FIG. 2). Outages (represented by symbol 310, analogous to symbol 210 in FIG. 2) are scheduled to occur during the superseding events and/or follower events. For example, consider the outage represented by symbol 310a. This outage was caused by the superseding event represented by symbol 301a. However, since the follower events represented by symbols 302, 304, 306 are within a predetermined temporal proximity to this outage, then the three follower events depicted by the symbol cluster 305 will also take place during the outage depicted by symbol 310a. Note that while follower events represented by symbols 302 and 306 were initially scheduled to be performed before the superseding event represented by symbol 301a, these events are still deemed follower events since the superseding event renders them unnecessary.

Note in timelines 308 and 312 that the next scheduled outage is depicted by symbol 310b, and will occur for follower events represented by cluster 307. However, the superseding event represented by symbol 301b will not be performed during the outage depicted by symbol 310b, since the superseding event represented by symbol 301b is temporally too distant (as previously determined) from the follower events represented by cluster 307. That is, a cost/benefit analysis has determined that it is too costly to accelerate the superseding event represented by symbol 301b to take place during the outage represented by symbol 310b. That is, while a superseding event may be slightly moved earlier (as shown in timeline 312), superseding events are not permitted to be accelerated more than a predetermined amount of time.

Timeline 314 depicts other scenarios in which superseding events and follower events are or are not consolidated during various outages.

Note that the criticality of performing a particular maintenance event may be static (e.g., certain preventive maintenance may be recommended by the manufacturer to occur at certain fixed time intervals). However, in one embodiment of the present invention the criticality is dynamically derived based on sensor readings on the equipment. These sensor readings give real time descriptions of the condition of equipment/components and/or their environment, which are then used to identify which maintenance events are “critical” (i.e., will result in the equipment failing if not performed). For example, consider equipment 400 depicted in FIG. 4. Assume that equipment 400 has three subcomponents 404a-404c. Associated with each of the subcomponents 404a-404c is a corresponding sensor 452a-452c (analogous to sensor(s) 152 shown in FIG. 1). Examples of such sensors include, but are not limited to, thermocouplers (electronic thermometers), mechanical pressure sensors, fluid (air and/or liquid) pressure sensors, vibration sensors, flow sensors (e.g., to measure fluid movement through a pipe, pump, etc.), tachometers (e.g., to measure the revolutions per minute (RPMs) being turned by a rotor that is supported by a roller bearing), etc. These sensors 452a-452c send readings to a preventive maintenance scheduling (PMS) server 402 (analogous to computer 102 shown in FIG. 1), which analyzes the readings.

For example, assume that subcomponent 404b is a roller bearing, and sensor 452b is a vibration detector. Assume further that the reading from sensor 452b shows an anomalous (i.e., too high) level of vibration in the roller bearing. Thus, replacing balls in the roller bearing is now deemed to be “critical” and needed within 12 hours, even though replacing the balls was scheduled as a non-critical event to take place in the future (e.g., months later). Therefore, if equipment 400 is scheduled to have a superseding event (which ordinarily would override the need to perform follower event maintenance on the subcomponents such as the roller bearing that is subcomponent 404b), this roller bearing will not be repaired/replaced, since the follower event for maintaining that roller bearing has now become “critical”.

In one embodiment, if a maintenance operation to a particular subcomponent dynamically becomes “critical”, then the critical/non-critical status of other subcomponents may also change. For example, assume that subcomponent 404a in FIG. 4 is a fluid reservoir, and subcomponent 404b is a fluid pump that pumps fluid from the fluid reservoir. Assume also that sensor 452a detects that the fluid reservoir has gone dry (is empty) for more than a certain amount of time (e.g., 8 hours). Even though sensor 452b may not detect a problem with the fluid pump, there is a strong likelihood that the impeller on the fluid pump has been damaged from running dry for so long. Thus, the follower event (e.g., inspection) of the fluid pump and/or its impeller may shift from non-critical to critical. Thus, while the equipment 400 is off line (i.e., is experiencing an outage) to repair the fluid reservoir (subcomponent 404a), the fluid pump (subcomponent 404b) will also be inspected, since this inspection has now been redefined from “non-critical” to “critical” based on the failure of the fluid reservoir (subcomponent 404a).

As described herein and in one embodiment of the present invention, the dynamic pulling back of an event is controlled by, but not limited to, the next scheduled maintenance event, the amount of outage time required to perform the event, the cost (financial, lost production, etc.) of the outage, the event cost (e.g., labor cost to perform the maintenance), one or more parts costs (i.e., how much the replacement part used during the maintenance costs), part life (i.e., how much remaining life is on the part that is being replaced early), and the pull back window. The pull back window is determined based on the rest of the factors (costs, part life, etc. just described). Once the pull back window is calculated, then event(s) are pulled back to the superseding event only if 1) they are within the determined pull back window, and 2) if the superseding event and the follower event can be performed together.

In one embodiment of the present invention, a follower event is pulled back according to the algorithm:

$${\sum }_{t}^{t + w} {o}_{t} \leq 1 … ∀ t$$

where: r is a predetermined time horizon (e.g., each subsequent day)
w is the pull back window (e.g., the next 30 days), and
Oₜ is the outage at time horizon t for each (∀) time horizon t

If an outage occurs at initial time tᵢ, then all of the follower events that were originally scheduled to occur between tᵢ and tᵢ+w will be pulled back to occur at time tᵢ. As described herein, the value of w is determined dynamically according to the remaining life of a part whose replacement is to be pulled back in time, the cost savings associated with pulling back that part replacement, etc.

In one embodiment, the pull back window w is determined according to:

w=T(fₘₐₓ((Cost_{cfe})*(WT_{cfe})+(Cost_{mfe})*(WT_{mfe}) . . . ∀t)

where:
T=the time interval T for each time horizon t (∀t)
Cost_{cfe}=the cost of a critical follower event (in time, labor, etc.)
WT_{cfe}=a predefined weighting for critical follower events
Cost_{mfe}=the cost of a minor follower event (in time, labor, etc.)
WT_{mfe}=a predefined weighting for minor follower events.

WT_{cfe} and WT_{mfe} are predefined such that WT_{mfe} is less than WT_{cfe}. That is, a critical follower event (i.e., an event that, if not performed, is determined to cause the system to catastrophically fail) is more important than a minor follower event (i.e., an event that, if not performed, will results in just a reduced performance, but not a total failure, of the system). Therefore, even if the cost of the minor follower event (Cost_{mfe}) is high, this cost is weighted low (WT_{mfe}), such that fₘₐₓ for that time period T will be low. That is, even though it may be very costly to perform that minor follower event at its originally scheduled time (and thus make it a good candidate for being pulled back to occur during the superseding event), the low value of its weight WT_{mfe} makes this cost insignificant, such that this time period T may not be the best period to assign the value of w.

Therefore, w defines the time period T during which the critical and minor follower events would have been performed if not pulled back to the outage, based on their maximum weighted costs. That is, if the cost of performing the critical and minor follower events that were initially scheduled to occur during time period T₁ (for a first time horizon t₁) is greater than the cost of performing these or other critical/minor follower events that were initially scheduled to be performed during time period T₂ (for a second time horizon t₂), then the critical/minor follower events that were initially scheduled to be performed during time period T₁ will be pulled back to the outage (i.e., are within the pull back window w). In one embodiment, the critical/minor follower events that were initially scheduled to be performed during time period T2 are not within w, and thus will be pulled back to the outage.

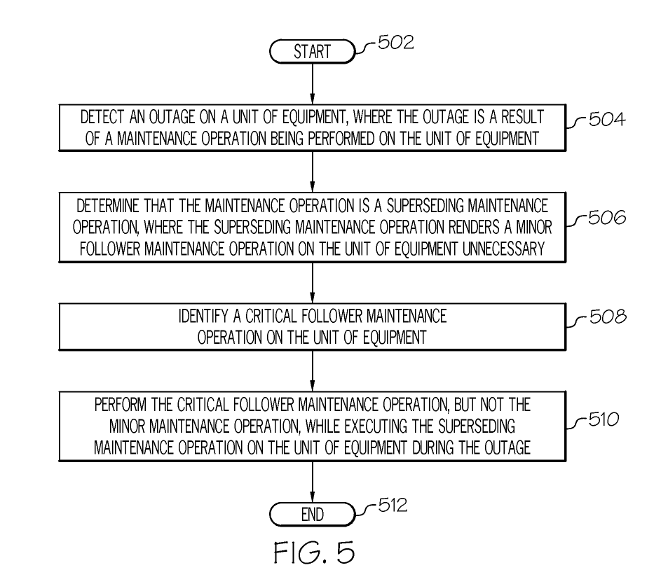

With reference now to FIG. 5, a high level flow-chart of one or more operations performed by one or more processors to schedule and/or manage preventive maintenance on equipment is presented. After initiator block 502, an outage on a unit of equipment is detected (block 504). This outage is the result of a maintenance operation being performed on unit of equipment. In particular and in one embodiment, the maintenance operation is being performed on a first subcomponent (e.g., subcomponent 404a) of the unit of equipment (e.g., equipment 400 shown in FIG. 4).

As described in block 506, a determination is then made that the maintenance operation on the equipment/subcomponent is a superseding maintenance operation. As described herein, a superseding maintenance operation renders a first minor maintenance operation on the first subcomponent of the unit of equipment unnecessary for preventing a failure of the unit of equipment, where the first minor maintenance operation is scheduled after the superseding maintenance operation.

As described in block 508, a first critical maintenance operation (e.g., the first critical follower maintenance operation) on the first subcomponent of the unit of equipment is then identified. This first critical maintenance operation was initially scheduled to be performed after the superseding maintenance operation, and failure to perform the first critical maintenance operation within a predefined period of time of the superseding maintenance operation has been predetermined to cause the unit of equipment to fail.

As described in block 510, the first critical maintenance operation, but not the first minor maintenance operation, is performed while executing the superseding maintenance operation on the first subcomponent of the unit of equipment during the outage. This semi-consolidation of maintenance events reduces the overall time (e.g., over the life of the unit of equipment) that the unit of equipment will have to be off line for maintenance. The process ends at terminator block 512.

In one embodiment of the present invention, a signal is received from at least one sensor (e.g., sensor 452a shown in FIG. 4) on the unit of equipment. This signal describes a state of the first subcomponent of the unit of equipment, such as its temperature, vibration, etc. Based on the signal describing the state of the first subcomponent of the unit of equipment, a determination is made that a maintenance operation on the first subcomponent of the unit of equipment is a critical maintenance operation that must be done within a certain time frame in order to avoid unacceptable damage to the equipment. In another embodiment, readings from the sensor(s) result in a determination that a maintenance operation on the first subcomponent of the unit of equipment is a minor maintenance operation, that is not critical to the operation of the equipment.

In one embodiment of the present invention, a second critical maintenance operation on a second subcomponent of the unit of equipment is identified. Like the first critical maintenance operations, this second critical maintenance operation is scheduled after the superseding maintenance operation, and failure to perform the second critical maintenance operation within a second predefined period of time of the superseding maintenance operation has been predetermined to cause the unit of equipment to fail. The second critical maintenance operation is performed while executing the first critical maintenance operations and the superseding maintenance operation, thus taking further advantage of the outage to the equipment during the superseding maintenance operation.

In one embodiment of the present invention, a cost of the first critical maintenance operation, a length of time required to perform the first critical maintenance operation at a different outage time from that incurred by the superseding maintenance operation, and a cost of the different outage time are all identified in order to determine a cost of performing the first critical maintenance operation at the different outage time. Based on this determined cost of performing the first critical maintenance operation, and in response to determining that the cost of performing the first critical maintenance operation at the different outage time is greater than a predetermined value, then a signal is issued to approve continuing the performance of the first critical maintenance operation during the outage. Alternatively and in another embodiment, in response to determining that the cost of performing the first critical maintenance operation at the different outage time is less than a predetermined value, then signal is issued to halt performance of the first critical maintenance operation during the outage.

In one embodiment of the present invention, a length of time between the outage and when the first critical maintenance operation was originally scheduled is identified. In response to determining that the length of time between the outage and when the first critical maintenance operation was originally scheduled is greater than a predetermined length of time, then a signal is issued to halt performance of the first critical maintenance operation during the outage.

As discussed herein, production reduction is a major issue due to unscheduled maintenance. The present invention presents a novel mechanism for generating a maintenance schedule for equipment, including a very complex machine such as a turbine, which has many sections, each section having many components, each component having many parts, each part having its own maintenance schedule, due to various failure times for each type of part. Based on the part life, part cost, event cost, required time to perform the maintenance, and outage cost, the present invention determines the number of outages along with the events to be performed with each outage. Dynamic pulling back of events (e.g., moving a scheduled maintenance operation from July back to April) along with dynamic outage time and superseding events are used to determine the preventive maintenance schedule.

As described herein, the present invention optimizes scheduling of equipment maintenance through the use of dynamic pulling back of events, superseding events and/or inspecting only critical part(s) during superseding events. According to one aspect of the present disclosure, a method and system for determining preventive maintenance schedule by reducing the number of outages for the given equipment is presented.

In one or more embodiments, the present invention provides a method and system to determine the dynamic pulling back of events along with dynamic outage to determine the maintenance schedule. Considering the next schedule of maintenance, required time to perform the outage, cost of outage, event cost (repair or replace or inspection) and part cost, outage of the equipment and pulling back of event are determined dynamically to achieve the objective.

Although described for exemplary purposes with regard to rotating equipment, such as turbines, the present invention is implementable in any industry, especially industries which have large and complex machines that require periodic maintenance. Examples of equipment in such other industries includes, but is not limited to, a dragline in an opencast mine, manufacturing equipment in the production industry, drilling rigs in the oil and gas industry, etc. Use of the invention as described herein will reduce the number of outages of equipment, reduce the loss of production, increase the reliability of the system, and reduce total maintenance cost in any such industry.

Note that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method to schedule preventive maintenance on a unit of equipment, the method comprising:
detecting, by one or more processors, an outage on a unit of equipment, wherein the outage is a result of a maintenance operation being performed on a first subcomponent of the unit of equipment;
determining, by one or more processors, that the maintenance operation is a superseding maintenance operation, wherein the superseding maintenance operation renders a first minor maintenance operation on the first subcomponent of the unit of equipment unnecessary for preventing a failure of the unit of equipment, and wherein the first minor maintenance operation is scheduled after the superseding maintenance operation;
identifying, by one or more processors, a first critical maintenance operation on the first subcomponent of the unit of equipment, wherein the first critical maintenance operation is scheduled after the superseding maintenance operation, and wherein failure to perform the first critical maintenance operation within a predefined period of time of the superseding maintenance operation has been predetermined to cause the unit of equipment to fail; and
performing the first critical maintenance operation, but not the first minor maintenance operation, while executing the superseding maintenance operation on the first subcomponent of the unit of equipment during the outage.

2. The method of claim 1, further comprising:
receiving, from at least one sensor on the unit of equipment, a signal describing a state of the first subcomponent of the unit of equipment; and
determining, based on the signal describing the state of the first subcomponent of the unit of equipment, that a maintenance operation on the first subcomponent of the unit of equipment is the first critical maintenance operation.

3. The method of claim 1, further comprising:
receiving, from at least one sensor on the unit of equipment, a signal describing a state of the first subcomponent of the unit of equipment; and
determining, based on the signal describing the state of the first subcomponent of the unit of equipment, that a maintenance operation on the first subcomponent of the unit of equipment is the first minor maintenance operation.

4. The method of claim 1, further comprising:
identifying, by one or more processors, a second critical maintenance operation on a second subcomponent of the unit of equipment, wherein the second critical maintenance operation is scheduled after the superseding maintenance operation, and wherein failure to perform the second critical maintenance operation within a second predefined period of time of the superseding maintenance operation has been predetermined to cause the unit of equipment to fail; and
performing the second critical maintenance operation while executing the first critical maintenance operation and the superseding maintenance operation.

5. The method of claim 1, further comprising:
identifying, by one or more processors, a cost of the first critical maintenance operation, a length of time required to perform the first critical maintenance operation at a different outage time from that incurred by the superseding maintenance operation, and a cost of the different outage time to determine a cost of performing the first critical maintenance operation at the different outage time; and
in response to determining that the cost of performing the first critical maintenance operation at the different outage time is greater than a predetermined value, issuing, by one or more processors, a signal approving continued performance of the first critical maintenance operation during the outage.

6. The method of claim 1, further comprising:
identifying, by one or more processors, a cost of the first critical maintenance operation, a length of time required to perform the first critical maintenance operation at a different outage time from that incurred by the superseding maintenance operation, and a cost of the different outage time to determine a cost of performing the first critical maintenance operation at the different outage time; and
in response to determining that the cost of performing the first critical maintenance operation at the different outage time is less than a predetermined value, issuing, by one or more processors, a signal to halt performance of the first critical maintenance operation during the outage.

7. The method of claim 1, further comprising:
identifying, by one or more processors, a length of time between the outage and when the first critical maintenance operation was originally scheduled; and
in response to determining that the length of time between the outage and when the first critical maintenance operation was originally scheduled is greater than a predetermined length of time, issuing, by one or more processors, a signal to halt performance of the first critical maintenance operation during the outage.
